(19) United States
(12) Patent Application Publication
(10) Pub. No.: US 2019/0139436 A1
(43) Pub. Date: May 9, 2019

(54) Virtual Reality Driving Simulator Rig

(71) Applicant: Mohamed Rustom Ashry, River Vale, NJ (US)

(72) Inventor: Mohamed Rustom Ashry, River Vale, NJ (US)

(73) Assignee: Defcon 5 Studios, LLC, River Vale, NJ (US)

(21) Appl. No.: 15/808,860

(22) Filed: Nov. 9, 2017

(51) Int. Cl. G09B 9/05; G09B 9/06; G09B 19/16

(52) U.S. Cl. CPC G09B 9/05; G09B 19/167; G09B 19/162; G09B 9/063

(57) ABSTRACT

A vehicle driving simulator rig is disclosed. The vehicle driving simulator rig includes a base, a seating area coupled to the base, and a virtual reality (VR) headset. At least one lighthouse is in communication with the VR headset and at least one support member holds the at least one lighthouse. The at least one support member is coupled to the base.

### BACKGROUND

Driving simulators are used to help train people to drive and control vehicles of all types including transportation vehicles, racing vehicles, and work vehicles. In most vehicle simulators, one or more video displays are used to give the user a feeling of being in a real world environment. Many driving simulators also use actuating systems that move a user to simulate motions of a real moving vehicle in action. It may be desirable to provide improvements to such useful systems.

### SUMMARY

An exemplary embodiment of the invention is directed to a vehicle driving simulator rig. The vehicle driving simulator rig comprises a base, a seating area coupled to the base, and, a virtual reality (VR) headset. At least one or more sensors are tracking the VR headset and corresponding trackable accessories and at least one or more support member(s) hold the at least one or more sensors. The at least one support member is coupled to the base.

In one exemplary embodiment, a platform is configured to support the seating area, a vehicle controller, and the at least one support member

In one exemplary embodiment, a platform is configured to support the seating area and the at least one support member. The platform and at least one support member are configured to conceal cabling from view.

In another exemplary embodiment, a vehicle simulation rig, comprises a base and a seat coupled to the base. An actuation system is coupled to the seat and the base. The vehicle simulation rig comprises a virtual reality (VR) headset, a vehicle controller, and at least one lighthouse in communication with the VR headset. The vehicle simulation rig also comprises a data processing unit running vehicle simulation software and providing signals to the VR headset, the actuation system, and the at least one lighthouse. The data processing unit receives information signals from the vehicle controller. The at least one support member hold the at least one lighthouse.

In yet another exemplary embodiment, a method of setting up a vehicle driving simulator rig is disclosed. The method comprises providing a seating area on a base, providing a vehicle controller, and providing a virtual reality (VR) headset. The method also includes adjusting at least one of the position and orientation of at least one lighthouse in communication with the VR headset. The at least one support member hold the at least one lighthouse and the at least one support member provide the adjustment mechanism.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an exemplary embodiment of a vehicle simulation rig in accordance with an exemplary embodiment.

FIG. 2 is an exemplary embodiment of a vehicle simulation rig in accordance with another exemplary embodiment.

FIG. 3 is an exemplary embodiment of a vehicle simulation rig in accordance with another exemplary embodiment.

FIG. 4 is an exemplary process diagram for setting up a vehicle simulation rig.

### DETAILED DESCRIPTION

In the following detailed description, reference is made to the accompanying drawings, which form a part thereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

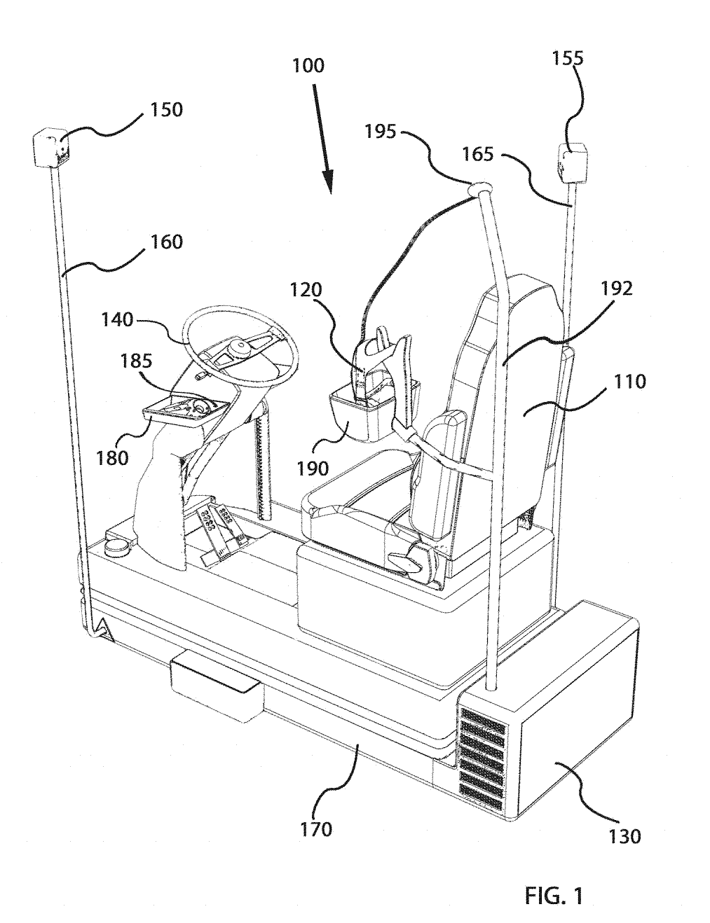

Referring now to FIG. 1, an exemplary vehicle driving simulator rig 100 is depicted. Rig 100 is an example of a vehicle simulation rig, which may be used to provide training for operators of any of a variety of vehicles including personal vehicles and work vehicles. For example, a personal vehicle may be a car, truck, boat, or the like. A work vehicle may be a garbage truck, farm vehicle, a construction vehicle or the like.

The vehicle driving simulator rig includes a seating area 110. Seating area 110 may be any kind of seating area including a bench, chair, racing seat, etc. Seating area 110 is used to seat an operator of vehicle driving simulator rig 100. In conventional vehicle driving simulator rigs, visual input to an operator is provided by one or more electronic display screens. Such display screens may provide an operator with a feeling of being in a real world environment. However, because an operator can see the rest of the room while viewing the display, the operator's senses are never really fooled that he or she is in a different real world environment. Thus, it is desirable to have a vehicle driving simulator rig 100 that utilizes a virtual\augmented reality (VR\AR) headset 120 for the operator instead of one or more external displays. The term virtual reality headset herein refers to both VR and AR headsets and headsets which may be configurable to operate as both VR and AR headsets, without departing from the scope of the invention. Virtual reality headset 120 provides an operator a more immersive experience in which an operator may feel substantially immersed in the environment being simulated. Use of VR headset 120 requires a data processing unit, which is housed in housing 130, to provide display signals to the headset displays and provide an immersive simulation experience. In an alternative embodiment, the data processing unit may be housed in other areas of simulator rig 100, such as within a base or platform 170. Also, the data processing unit may be housed directly on VR headset 120.

Use of VR headset 120 also requires a way to determine the location and orientation of the operator and more specifically the operator's head. In accordance with an exemplary embodiment, VR headset 120 may be an Oculus Rift, an HTC Vive, a Playstation VR or any of a variety of other similar, third party, VR headset devices. Generally, the VR headsets may be any of three types. First, the VR headset may have electromagnetic (EM) radiation sensors thereon which sense radiation from external EM emitters. Second, the VR headset may be of the type that has EM radiation emitters thereon which emit EM radiation to be detected by external EM radiation sensors. Third, the VR headset may be of the type that has at least one camera thereon, the at least one camera used to detect the location of at least one marker or landmark located near the user.

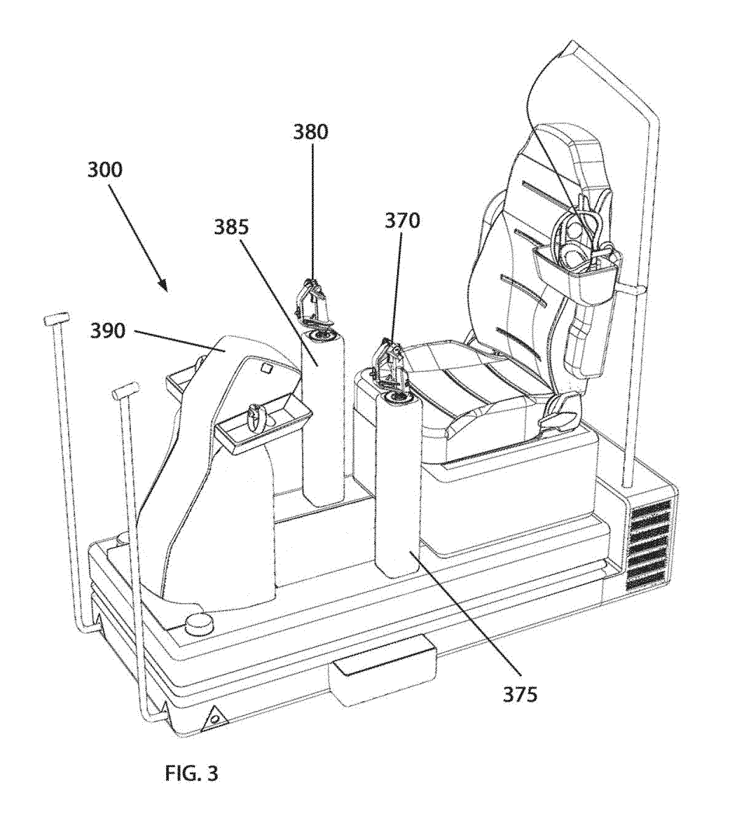

Rig 100 utilizes a vehicle controller 140 which is used for an operator to provide input to rig 100 and provide simulated operation of a personal or work vehicle. Vehicle controller 140 may be any of a variety of controllers including a steering wheel as depicted. Alternatively, vehicle controller 140 may be any of a variety of other controllers including shift levers, foot pedals, buttons, joysticks, knobs, etc. depending on the virtual vehicle being controlled. In an exemplary embodiment, vehicle controller 140 may be swappable with other vehicle controllers so that rig 100 may be reconfigured for various types of vehicle simulations. Referring to FIG. 3, a simulation rig 300 is depicted. Simulation rig 300 is similar to simulation rig 100, but includes a pair of joysticks 310 and 320 which have been swapped out in place of a steering wheel or other vehicle controllers. In some configurations it may be desirable two swap out the two joysticks 310 and 320 for a single joystick which may be directly in front of seating area 330. Alternatively, one of joysticks 310 or 320 may be used without the other. Other alternative configurations and types of controllers are possible without departing from the scope of the invention. In an alternative embodiment, no physical controllers are used, rather any vehicle controllers may be created via software as virtual controllers.

Rig 100, which utilizes a VR headset, like the HTC Vive, includes sensors 150 and 155 that used to track the VR headset 120 and its corresponding accessories through the data processing unit or computer housed in housing 130. Lighthouses 150 and 155 provide electromagnetic radiation signals, such as infrared light, which is detected by multiple sensors on VR headset 120. In an exemplary embodiment support members 160 and 165 hold lighthouses. Support members 160 and 165 may be configured to be mechanically adjustable in height and may be configured to be mechanically adjustable in orientation. Such adjustment allows for different size of operators and different seating arrangements to be used such that lighthouses 150 and 155 are pointed in the correct direction to detect the motions of the operator. Lighthouses in this context may refer to devices which emit light signals or receive light signals via sensors or a combination of emitters or sensors. They may also be “landmarks” or markers such that camera based VR headsets may orient themselves based on their fixed position. Such landmarks may be either electronic, such as various types of light, or nonelectronic, such as a colored ball, a QR code, or the like. In some embodiments the lighthouse height may be adjustable by repositioning along the length of the support members. In other embodiments the support members themselves may be mechanically adjustable in height. The angle and orientation of the lighthouse may be adjustable using any of a variety of mechanical means including but not limited to hinge joints, ball and socket joints, etc.

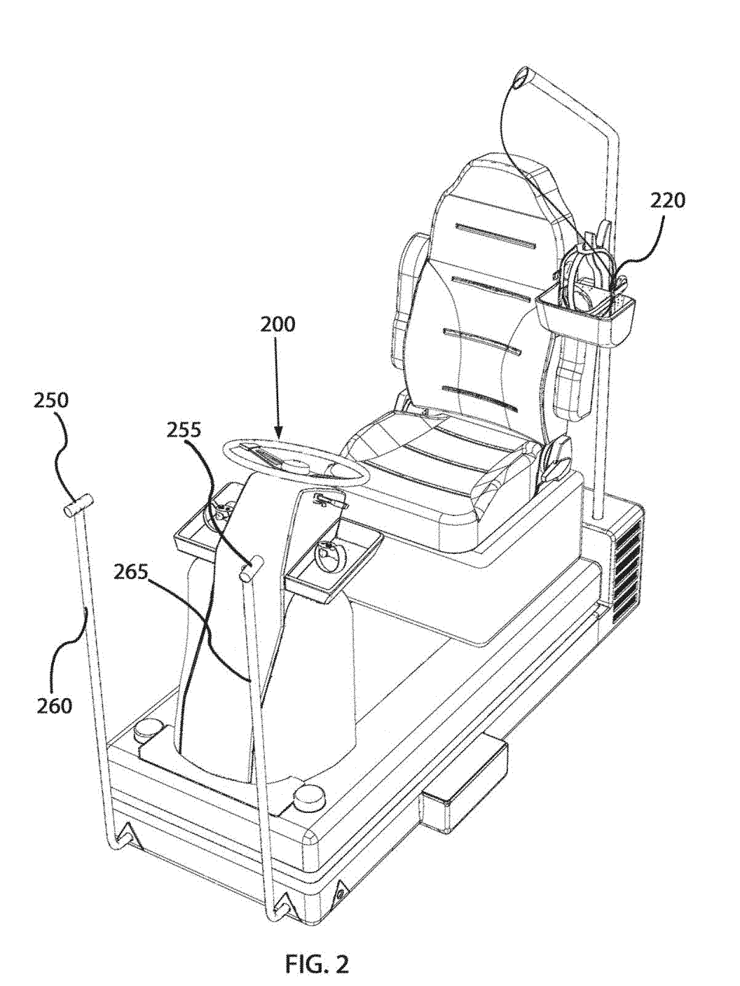

Depending on what type or brand of VR headset is used, lighthouses 150 and 155 may be any of electromagnetic (EM) radiation emitters, such as but not limited to infrared light emitters. Referring to FIG. 2, an alternative embodiment of a vehicle simulation rig 200 is depicted. Rig 200 is, in most aspects, similar to that of rig 100 depicted in FIG. 1 except that rig 200 uses a different type of VR headset 220 such as an Oculus Rift or the like. Headset 220 includes infrared or other emitters mounted on the headset. IR sensors 250 and 255 are mounted to support posts 260 and 265 respectively. Sensors 250 and 255 are configured to detect emitted radiation from headset 220 from which position and orientation of a user, or portions of a user may be determined.

Referring again to FIG. 1, in an exemplary embodiment support members for lighthouses 150 and 155 may be posts 160 and 165. The location of one or more of posts 160 and 165 may be moved relative to the other posts. A base or platform 170 may have a variety of positions which are able to accept posts 160 and 165. Posts 160 and 165 may swivel at the attachment location to base 170. This allows the lighthouses to be outside of the footprint of base 170.

In an exemplary embodiment, posts 160 and 165 may be hollow or have a cavity that receives electrical cables therethrough or therein and conceals the electrical cables from view. Platform 170 is configured to support seating area 110, the vehicle controllers, and the posts 160 and 165 for supporting the lighthouses. Additionally platform 170 is configured to support computer housing 130. The platform may include one or more locations for the vehicle controllers to be adaptable to simulate various vehicles. In some embodiments, a holder 180 may be provided for holding a controller or other accessories. Proximate holder 180 may be a charging port 185 for battery operated accessories or wireless controllers. Port 185 may be a connector such as a USB or other electrical connector. Alternatively, port 185 may just be a hole that provides a place for running a charging cable to the interior of rig 100 where connectors or power strips can be provided.

In an exemplary embodiment a VR headset rest 190 is coupled to a portion of rig 100 for holding the VR headset when not in use. Headset rest 190 may be supported by a post 192. Post 192 may be hollow or with a cavity to conceal, from view, VR headset cables running from the VR headset 120 to the data processing unit. In some embodiments, post 192 extends above a typical users head so that the headset cable does not place much weight on the headset while being worn by a user. Also, in an exemplary embodiment, a spring operated or motorized retraction mechanism may be provided at the bottom of post 192 within the base 170 or housing 130 which is used to actively or passively retract any slack cabling. In an exemplary embodiment, post 192 is fitted with an approximately frustoconical shaped cable exit section 195 at the top of post 192. The frustoconical exit section provides an exit area for the VR headset cable with minimal drag of the cable on an exit aperture thereby minimizing any pull caused by the cable on the headset when in use.

In some exemplary embodiments, the platform is coupled to at least one actuator that is configured to selectively move at least a portion of the platform according to signals received from the data processing unit. In some embodiments, the platform is coupled to at least one actuator configured to selectively move at least the seating area according to signals received from the data processing unit. These actuators may be electric, hydraulic, or mechanical, etc.

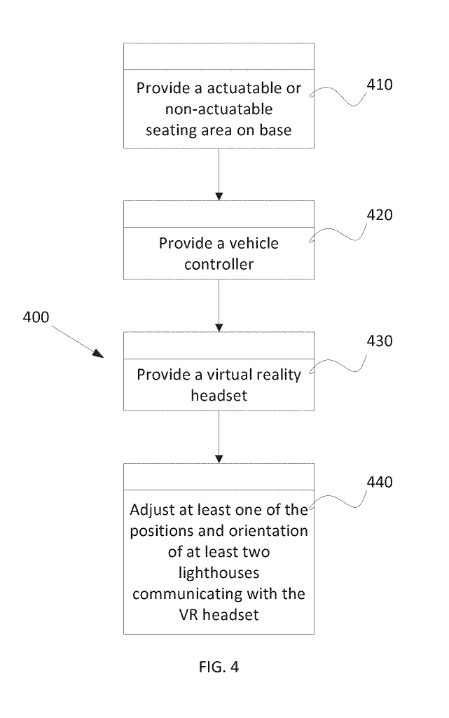

Because of the modularity of the VR vehicle simulation rig, setting up of the vehicle driving simulator rig includes multiple steps as depicted in FIG. 4. A process 400 is depicted in which a seating area on a base is provided (process 410), a vehicle controller (process 420) is provided, and a VR headset is further provided (process 430). The vehicle controller may be provided as a physical input device such as, but not limited to a steering wheel or a joystick, or the vehicle controller may be a virtual control which can be viewed and interacted with in the virtual environment of the VR headset. Process 400 also includes adjusting at least one of the position and orientation of at least two lighthouses in communication with the VR headset on at least two support members holding the at least two lighthouses and the at least two support members providing the adjustment mechanism (process 440). In some exemplary embodiments process 400 may include a step of concealing cabling for any wired accessories of the system within the posts and under the base such that most of the cabling remains concealed from view. Also in some processes, it may be desirable to provide an actuatable base as opposed to an actuatable seating area. In addition, in some exemplary embodiments it may be desirable to provide the ability to switch out different virtual vehicle controllers for different types of controllers.

It is significant to note, although described in the description above, that most or all of the accessories and devices of the simulator rigs 100, 200, or 300 are all designed to be plug and play. For example, the landmarks, the wheels, joysticks, pedals, cpu, VR headsets and controllers, lighthouses, motion actuator, etc. may all be 3rd party and can be easily integrated into the body. This may also include the frame, support members, cable management (tubing, fasteners), attachable/detachable supports for joysticks and other support members. Because of the plug and play nature of the simulator rig, it is also important to have an availability of power sources within platform 170 for example as well as within housing 130. In exemplary embodiments a variety of power strips and transformers can be located hidden from view within platform 170 or housing 130. These power strips may be plugged into a main power source that exits platform 170 through a single aperture and can be plugged into an external electrical socket to provide power to the entire system. Power strips within platform 170 and housing 130 allow for plug and play controllers, CPUs, sensors, actuators, etc. to be provided with power while maintaining the cabling out of plain sight.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. In addition, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A vehicle driving simulator rig, comprising:
a base;
a seating area coupled to the base;
a virtual reality (VR) headset;
at least one lighthouse; and
at least one support member holding the at least one lighthouses, the at least one support member coupled to the base.

2. The vehicle driving simulator rig of claim 1, wherein the VR headset includes electromagnetic radiation sensors coupled to the headset.

3. The vehicle driving simulator rig of claim 1, wherein the VR headset includes at least one camera on the headset.

4. The vehicle driving simulator rig of claim 1, wherein the VR headset includes at least one electromagnetic radiation emitter on the headset.

5. The vehicle driving simulator rig of claim 1, further comprising a vehicle controller that is swappable with more than one type of controller.

6. The vehicle driving simulator rig of claim 1, further comprising a vehicle controller that includes at least one joystick.

7. The vehicle driving simulator rig of claim 1, further comprising a vehicle controller that includes at least one steering wheel.

8. The vehicle driving simulator rig of claim 1, further comprising a vehicle controller that includes at least one foot pedal.

9. The vehicle driving simulator rig of claim 1, further comprising a vehicle controller that exists in software and can be seen using the VR headset in VR space.

10. The vehicle driving simulator rig of claim 1, wherein the lighthouses include at least one electromagnetic radiation emitter.

11. The vehicle driving simulator rig of claim 1, wherein the lighthouses include at least one electromagnetic radiation sensor.

12. The vehicle driving simulator rig of claim 1, wherein the lighthouses include a marker viewable by at least one camera on the VR headset.

13. The vehicle driving simulator rig of claim 1, wherein the at least one of the at least one support member is adjustable in height.

14. The vehicle driving simulator rig of claim 1, wherein the at least one of the at least one support member is adjustable in position.

15. The vehicle driving simulator rig of claim 1, wherein the at least one of the at least one support member is adjustable in orientation.

16. The vehicle driving simulator rig of claim 1, wherein the at least one of the at least one support member is a post.

17. The vehicle driving simulator rig of claim 1, wherein the at least one of the at least one support member can be moved in location relative to the other support members.

18. The vehicle driving simulator rig of claim 1, wherein the at least one support member include a cavity for receiving electrical cables.

19. The vehicle driving simulator rig of claim 1, wherein a platform is configured to support the seating area, the vehicle controller, and the at least two posts.

20. The vehicle driving simulator rig of claim 1, wherein the platform supports a data processing unit module.

21. The vehicle driving simulator rig of claim 1, wherein the platform includes more than one location for the vehicle controller.

22. The vehicle driving simulator rig of claim 1, wherein the platform supports a charging port for charging battery operated accessories.

23. The vehicle driving simulator rig of claim 1, wherein the platform supports a VR headset rest area for holding the VR headset when not in use.

24. The vehicle driving simulator rig of claim 1, wherein the platform is coupled to at least one actuator configured to selectively move at least a portion of the platform.

25. The vehicle driving simulator rig of claim 1, wherein the platform is coupled to at least one actuator configured to selectively move at least the seating area.

26. A vehicle simulation rig, comprising:
a base;
a seat coupled to the base;
an actuation system coupled to the seat and the base;
a virtual reality (VR) headset;
a vehicle controller;
at least one lighthouse in communication with the VR headset;
a data processing unit running vehicle simulation software and providing signals to the VR headset, the actuation system and the at least one lighthouse, the data processing unit receiving information signals from the vehicle controller; and
at least one support member holding the at least one lighthouse.

27. A method of setting up a vehicle driving simulator rig, comprising:
providing a seating area on a base;
providing a virtual reality (VR) headset;
adjusting at least one of the position and orientation of at least one lighthouse in communication with the VR headset, the at least one support member holding the at least one lighthouse and the at least one support member providing the adjustment mechanism.

28. The method of claim 27, further comprising: coupling a vehicle controller to the vehicle driving simulator rig.
